(19) United States
(12) Patent Application Publication
(10) Pub. No.: US 2015/0170424 A1
(43) Pub. Date: Jun. 18, 2015

(54) SYSTEMS AND METHODS FOR UNFOLDING MESHES

(71) Applicant: Google Inc., Mountain View, CA (US)

(72) Inventors: Aleksey GOLOVINSKIY, Mountain View, CA (US); Michael Hongmai Lin, Mountain View, CA (US)

(21) Appl. No.: 13/653,344

(22) Filed: Oct. 16, 2012

(51) Int. Cl. G06T 19/20; G06K 15/02; G06T 17/20

(52) U.S. Cl. CPC G06T 19/20; G06T 17/20; G06K 15/024; G06K 15/1848; G06T 2219/2004

(57) ABSTRACT

The subject matter of this specification can be implemented in, among other things, a method for generating a set of planar mediums (e.g., pages) for three dimensional model construction. The method includes a step for receiving three dimensional object data from a client computing device. The method includes a step for categorizing the three dimensional object data into a plurality of faces, wherein each face represents a two dimensional polygon of a part of the three dimensional object, and wherein connectivity information for each face of the plurality of faces to other faces of the plurality of faces is maintained. The method includes a step for selecting two faces from the plurality of faces for digital joining. The method includes a step for digitally joining the selected two faces to fit on a planar medium. The method includes a step for generating one or more digital images which contain the digitally joined faces from the plurality of faces.

### FIELD

This subject technology relates to model construction, in particular to constructing three dimensional models.

### BACKGROUND

Users may want to construct three dimensional (3D) models from flat physical mediums, such as paper. For example, a user may print out pages that consist of images that make up a 3D building and cut each image on the pages to glue together to construct a model of the 3D building. Constructing 3D models from printing the associated pages, perhaps comprising of one page per face of the 3D surface, may involve substantial cutting and gluing of many different segments of the building. Thus, it may be desirable to provide systems and methods to reduce or make more efficient the work required to construct 3D models.

### SUMMARY

The disclose subject matter relates to a method for generating a set of planar mediums (e.g., a set of pages) for three dimensional model construction. In one aspect, a method includes a step for receiving three dimensional object data from a client computing device. The method also includes a step for categorizing the three dimensional object data into a plurality of faces, wherein connectivity information for each face of the plurality of faces to other faces of the plurality of faces is maintained. The method also includes a step for selecting two faces from the plurality of faces for digital joining. The method also includes a step for digitally joining the selected two faces to fit on a planar medium. The method also includes a step for generating one or more digital images which contain the digitally joined faces from the plurality of faces.

The disclosed subject matter further relates to a non-transitory computer-readable medium. The computer-readable medium includes instructions that, when executed by a computer, cause the computer to implement a method for generating a set of planar mediums (e.g., a set of pages) for three dimensional model construction. The instructions include code for receiving three dimensional object data from a client computing device. The instructions also include code for categorizing the three dimensional object data into a plurality of faces, wherein each face represents a two dimensional polygon of a part of the three dimensional object, and wherein connectivity information for each face of the plurality of faces to other faces of the plurality of faces is maintained. The instructions include code for selecting two faces from the plurality of faces for digital joining. The instructions also include code for digitally joining the selected two faces to fit on a planar medium. The instructions include code for generating one or more digital images which contain the digitally joined faces from the plurality of faces.

The disclosed subject matter further relates to a system for generating a set of planar mediums (e.g., a set of pages) for three dimensional model construction. The system includes one or more processors and a memory including instructions which, when executed by the one or more processors cause the one or more processors to receive three dimensional object data from a client computing device. The instructions also cause the one or more processors to categorize the three dimensional object data into a plurality of faces, wherein each face represents a two dimensional polygon of a part of the three dimensional object, and wherein connectivity information for each face of the plurality of faces to other faces of the plurality of faces is maintained. The instructions also cause the one or more processors to select two faces from the plurality of faces for digital joining. The instructions also cause the one or more processors to digitally join the selected two faces to fit on a planar medium. The instructions also cause the one or more processors to generate one or more digital images which contain the digitally joined faces from the plurality of faces.

The details of one or more implementations are set forth in the accompanying drawings and the description below. Other features and advantages will be apparent from the description and drawings, and from the claims.

### DESCRIPTION OF DRAWINGS

FIG. 1 is a schematic diagram that shows an example of a system for model construction.

FIG. 2 illustrates an example of the server of FIG. 1 in more detail.

FIGS. 3A-3F illustrate an example of a 3D building and the pages resulting from applying a system 200 for model construction to the 3D building.

FIGS. 4A-4E illustrate an example of a 3D rectangular box and the pages resulting from applying a system 200 for model construction to the 3D rectangular box.

FIG. 5 is a flow chart that shows an example of a process for model construction.

FIG. 6 conceptually illustrates an example electronic system with which some implementations of the subject technology are implemented.

### DETAILED DESCRIPTION

This document describes systems and techniques for model construction of 3D objects (e.g., a building, a bridge, etc.) In various aspects, a system for model construction takes a representation of a 3D model, e.g., as a mesh, and unfolds it onto several pieces of paper or pages for a user to print, cut, and glue to construct the 3D model. Data representing an input 3D surface may include a list of vertices, edges, along with connectivity information between edges, and a list of faces that make up the 3D surface. Each face may include one image, more than one image, or pieces of a larger image. Each face may represent a polygon that could individually be cut and connected with other faces, along the appropriate edge(s) to create the 3D model. Each face may represent a mixture of polygon shapes or other two-dimensional shapes (e.g., non-polygonal faces) that have non-linear edges connecting one or more other faces also having a non-linear edge.

As one example, a user browsing a website containing various images of 3D objects (e.g., an image of a historic building of interest) may click on the building and provide it to a model construction system (e.g., by right clicking and selecting a model construction option on a pop-up menu, etc.) The model construction system may then take the 3D data and render a set of planar mediums (e.g., a set of multiple pages) of faces that make up the building as output for the user. The user may then print the pages containing the faces, and cut, fold, and glue the pieces together to construct a 3D model of the historic building of interest to the user.

In various aspects, methods and systems are provided for optimizing 3D model construction. An optimized system may minimize or make more efficient (e.g., select easier cuts although not the minimum number) the cuts and gluing required for reconstruction of a 3D model from printed planar mediums, such as a set of pages. An optimized system as described herein does not necessarily indicate a global optimization. Rather, the optimized system is a model construction system that is more optimal than a model construction system where each face of a 3D mesh is provided on an individual page or planar medium, to manually cut, manually insert tabs, manually glue, and without any attempt to combine one or more faces on a single page or planar medium.

In some aspects, a model construction system takes a 3D mesh as input, and places one of its faces down on a first planar medium (e.g., a first piece of paper to print for model construction). The system then unfolds the 3D mesh at any given edge, calculating various values (e.g., perimeter for cutting, etc.) to see if the selected edge for unfolding is optimal. If the calculated values indicate that the unfolding is optimal then the unfolding at that edge may be maintained, otherwise another edge to unfold at may be selected. Also, if the unfolding leads to an intersection or overlapping (e.g., when upon unfolding, one or more faces occupy the same space on the paper plane or the planar medium as other faces previously unfolded as a 2D layouts, e.g., in the case of a concave 3D model provided as input), then the system may move those pieces to another page (e.g., a second piece of paper for printing) or planar medium. In some implementations, the process of unfolding at edges is repeated until the input 3D mesh is unfolded onto one or more 2D planar mediums (e.g., perhaps designed to fit one image, having one or more faces, per page or some other planar medium). The described unfolding strategy may work well for convex shapes but may not be efficient and may be difficult to implement for concave shapes in a 3D surface.

In various other aspects, a system for 3D model construction utilizes a conceptual reversal of the unfolding strategy described above (or selective face aggregation technique). The system begins by creating digital cuts for each face of an input 3D mesh. The system then combines two faces having a common edge together, a virtual gluing process (e.g., the two faces may be digitally joined into one image). Two faces selected for combining may be determined based on various optimization algorithms (e.g., combine two edges that lead to the smallest perimeter or combine two of the longest edges first, etc.). The step for combining two faces may be repeated until all of the faces, produced by the digital cuts of the input 3D mesh, have been processed (e.g., an attempt has been made for each face of the set of digitally cut faces to be joined with at least one other face). In some cases, one or more faces may not be joined to any other face, e.g., because the one or more faces may be so large as to use up the space on one page or other planar medium for the face itself. In other cases, one or more faces may be joined to one or more other faces. The result may be multiple pages, each containing one or more combined faces or individual faces, for printing, cutting, and gluing to construct the desired 3D model. The multiple pages may be stored in a persistent storage for later use by a requesting user or other users.

In some implementations, at each step of virtual gluing checks, various constraints are checked prior to making the decision to virtually glue two faces together. For example, a check may be made to ensure that the two faces that are being virtually glued together do not overlap with any other faces or combined faces, before deciding on virtually gluing them. In some implementations, a check to ensure that two faces do not overlap with other faces is done at each step of deciding to virtually glue two faces (e.g., to avoid two overlapping faces in the 2 dimensional layout). Also, another check may be to ensure that there is enough space on a particular planar medium (e.g., a page on which the 2D image, combining the two or more faces, will be printed) for the combined faces. Where there is not enough space, the system may continue the joining on a next planar medium (e.g., a next page).

In some aspects, one or more tabs is added on one or more edges that will need to be glued to another edge for model construction. As such, another constraint before virtually gluing two faces together may be to ensure that possible tabs that need to be added to an edge do not overlap with other tabs and do not overlap with faces. Additionally, tab placement may restrict virtually gluing of two faces where the tab placement may result in not leaving enough space on the planar medium on which the two faces are being joined.

The systems and techniques described here may provide one or more of the following advantages. One advantage is that a user may need to cut fewer edges in order to construct a 3D model. Another advantage may be that the type of cuts required may be easier due to a more optimal selection of faces that are joined. Additionally, where tabs are added to edges for gluing, a user may not need to manually insert such tabs prior to gluing two faces of a 3D model together. The described selective face aggregation technique provides another important advantage of being simple to conceptualize and implement.

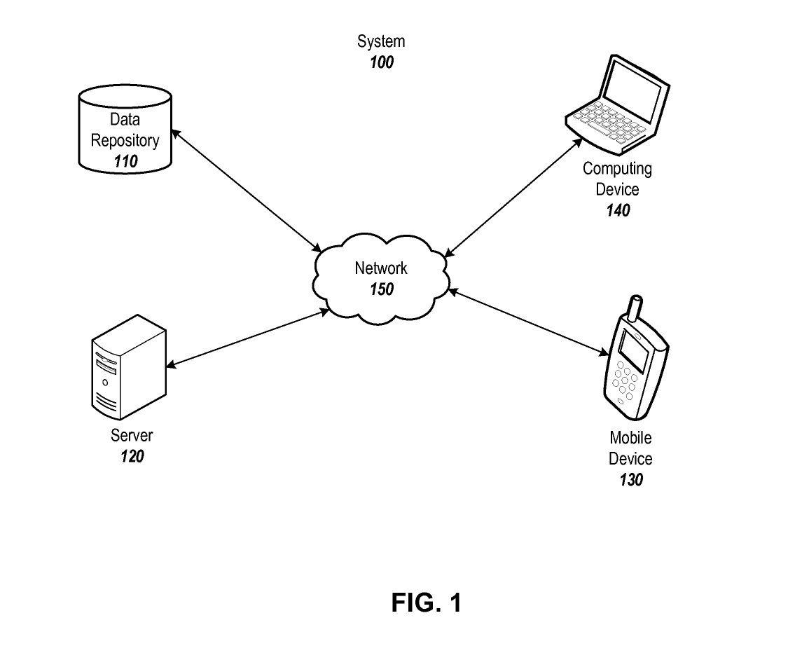

FIG. 1 illustrates an example of a computer system 100 configured to provide an optimized system for 3D model construction. As shown, the computer system 100 includes a data repository 110, a server 120, a mobile device 130 and a computing device 140. Data repository 110, although shown as a database, may be any other type of data repository (e.g., a relational database, an object-oriented database, a web application server, a file, or any other data storage) that can maintain and provide data about needed for 3D model construction systems. The data repository 110, the server 120, the mobile device 130, and the computing device 140 may be configured to communicate with one another via a network 150. The network 150 may include the Internet, an intranet, a local area network, a wide area network, a wired network, a wireless network, a cellular network, a WiFi network, or a virtual private network (VPN).

The data repository 110 may store data (e.g., 3D mesh data, 2D layouts or the pages or planar mediums that comprise the images and faces making up a 3D model surface, etc.) related to a model construction system. The database may include a single machine, multiple machines, a single processor system, or a multi-processor system.

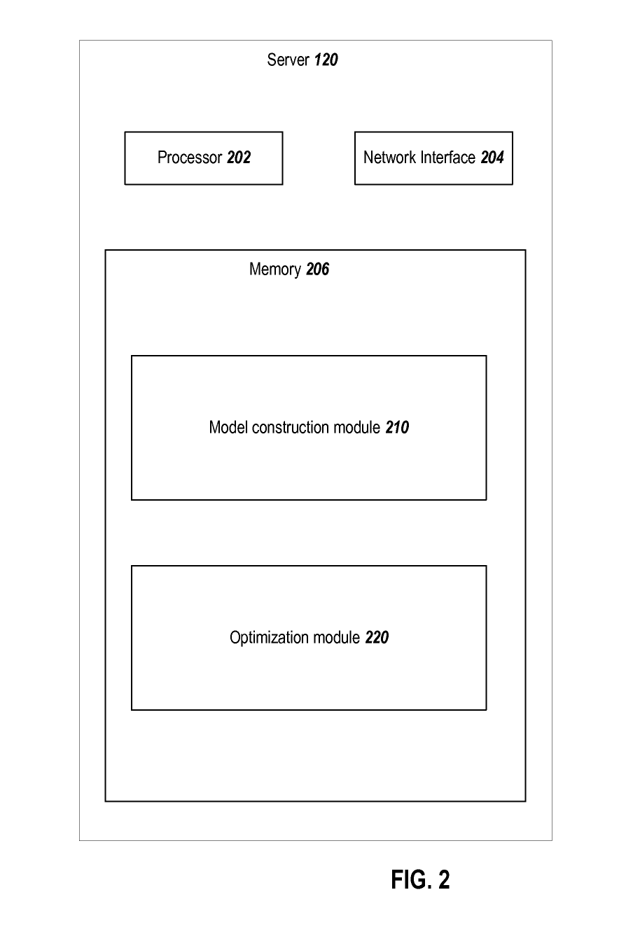

The server 120 may include a module for model construction and a module for optimization (e.g., for selection of two faces for virtual gluing or for tab placement). The server 120 may be implemented as a single machine with a single processor, a multi-processor machine, or multiple machines with multiple processors. One example of the server 120 is described in more detail in conjunction with FIG. 2 below.

The mobile device 130 may be a mobile phone, a personal digital assistant (PDA), a tablet computer, a netbook, or a laptop computer. The mobile device 130 may be portable and may often times be carried by a user, for example, in a pocket, a purse, a backpack, or a briefcase. The mobile device 130 may also include a mobile browser or a mobile application configured to take a 3D mesh as input to provide to a server 120 and to request and receive a set of pages or other planar mediums containing the images (for model construction) for the provided 3D mesh. While only one mobile device 130 is illustrated in FIG. 1, the subject technology may be implemented in conjunction with one or more mobile devices 130.

The computing device 140 may be a laptop computer, a desktop computer, a mobile phone, a personal digital assistant (PDA), a tablet computer, a netbook, a television with one or more processors embedded therein or coupled thereto, a physical machine, or a virtual machine. The computing device 140 may include one or more of a keyboard, a mouse, a display, or a touch screen. The computing device 140 may also include a web browser or an application configured to take a 3D mesh as input to provide to a server 120 and to request and receive a set of pages of images (for model construction) for the provided 3D mesh.

While each of the data repository 110, the server 120, the mobile device 130, and the computing device 140 are illustrated in FIG. 1 as separate machines, in example aspects, one or more of the data repository 110, the server 120, the mobile device 130, and the computing device 140 may be implemented as a single machine. For example, the functions of the data repository 110 and the server 120 may be implemented within a single machine.

FIG. 2 illustrates an example of the server 120 of FIG. 1 in more detail. As shown, the server 120 includes a processor 202, a network interface 204, and a memory 206. The processor 202 is configured to execute computer instructions that are stored in a computer-readable medium, for example, the memory 206. The processor 202 may be a central processing unit (CPU). While only one processor 202 is illustrated, the server 120 may include multiple processors. Furthermore, while the server 120 is illustrated as a single machine, the server 120 may include multiple machines, e.g., within a server farm. The network interface 204 is configured to allow the server 120 to transmit and receive data in a network, e.g., network 150 of FIG. 1. The network interface 204 may include one or more network interface cards (NICs). The memory 206 may store data or instructions. As illustrated, the memory 206 includes a model construction module 210 and an optimization module 220, which are implemented by processor 202 executing one or more sequences of instructions stored in memory 206.

The model construction module 210 is configured to facilitate receiving, from a client device (e.g., computing device 140 or mobile device 130), a request for model construction. For example, the request may be for a set of pages or other planar mediums, containing the required faces, to be able to print, cut, fold, and glue to create a 3D model. In some aspects, the model construction module 210 is configured to receive a 3D mesh as an input for a model construction request and output a set of digital images or set of planar mediums containing optimally joined faces. Model construction module 210 may also receive data about a 3D surface in any other format that can capture 3D surface information.

In various aspects, model construction module 210 is configured to facilitate the implementation of the selective face aggregation technique for model construction (as discussed above). Model construction module 210 may take a 3D mesh as input (e.g., representing a 3D surface or object), provided by a user of mobile device 130 or computing device 140 and digitally cut or categorize each original face of the 3D mesh to create a set of faces that make up the 3D object. A face may represent a polygon or other non-polygon shapes (e.g., a face having a non-linear edge) that may be joined with other faces in the set of faces to construct a 3D surface or object. The digital cutting or categorizing may result initially in each face being on a separate page or other planar medium. Model construction module 210 may maintain connectivity information between faces. For example, connectivity information may include information about vertices and edges that join one face with another face. Model construction module 210 may provide the set of digitally cut faces to optimization module 220 for determination of which two faces may be optimal to combine.

In some implementations, model construction module 210 is also configured to take two faces and join them together virtually or digitally. The two selected faces for combining may have one edge in common with each other. In system 200, model construction module 210 is configured to communicate with optimization module 220 to receive information about which two faces should be digitally joined. Once two original faces have been digitally combined, the new connected component or new face, including the original two faces, may be added back to the set of digitally cut faces, and the two original faces that were combined may be marked as already processed or may be deleted from the set of digital cuts. By adding the new face or connected component back to the set of faces, the system may make it possible to join multiple original faces together, because for example, a connected component with the original two faces joined may be selected to join or virtually glue yet again with another original face or with another previously combined component.

As such, the resulting combined component may be referred to yet again as a face or a new face. And a face as used in this disclosure includes an original face, resulting from digital cutting, or a new face resulting from combining an original face with another original face, or resulting from combining an original face with a combined component, or from combining a combined component with another combined component.

The step to combine two optimal faces may be repeated by model construction module 210 until there are no longer any disconnected segments in the set of digital cuts, so long as the remaining faces, original or new faces as a result of virtual joining, do not overlap, or until all of the faces in the set have been processed (e.g., an attempt to connect each face to another face or connected component has been made).

Model construction module 210 may continue combining two faces on the planar medium (e.g., a current planar medium) until there is no more space on that planar medium. Model construction module 210 may stop adding more faces to a current planar medium once there is no more space on that particular planar medium. The current planar medium may then be added to a set of planar mediums for model construction (e.g., to keep track of all the planar mediums or pages containing digitally joined faces for the provided 3D mesh). A next planar medium may then be selected to combine one or more of the remaining faces in the set of digital cuts or combined components. Model construction module 210 may continue this process until all the faces in the set of faces have been processed (e.g., until no more faces remain in the set of categorized or digitally cut faces). It is possible that one or more faces may not be joined with any other face (e.g., when one face is large enough to occupy most of the space on the size of the planar medium being used).

Model construction module 210 is also configured to take two or more planar mediums in the set of planar mediums, and place the images (e.g., containing the images of the joined faces) on one planar medium where space allows such combining. For example, in a first iteration or attempt to combine faces, model construction module 210 may yield four planar mediums (containing one or more combined faces), e.g., respectively 80%, 60%, 40%, and 20% full. Model construction module 210 may then attempt to combine planar mediums in the resulting set of planar mediums to further optimally use the available or left over space on one or more of the planar mediums. For example, Model construction module 210 may place the combined images from the 4 planar mediums to yield two planar mediums, each being 100% full. This may be achieved, for example, by placing the images from the 20% full page on the 80% full page and placing the images from the 40% full page on the 60% full page.

Model construction module 210 may represent an edge as a solid line. In some aspects, e.g., where data for a 3D structure is provided with stacked 3D sub-structures (e.g., a cube with another cube placed over it), model construction module 210 represents edges for the faces that connect the two sub-structures or cubes as dotted lines. The dotted lines may indicate that no cut should be performed along those edges. Model construction module 210 may contain any edge as a dotted line, indicating that no cutting is required.

In various aspects, model construction module 210 is configured to add one or more tabs to one of each of a set of two edges, that may need to be glued together. Tabs may be shown with a dotted edge, indicating that no cut is required at the dotted line, and instead a fold should take place at that dotted line for gluing with an adjacent face, joined by a common edge. Adding a tab may make it easier for a user to construct a 3D model because the user may not need to manually insert a tab for gluing two edges. Tabs may be added by iterating through all edges (e.g., in the set of pages created from virtually gluing of one or more faces), in any order, and attempting to add one or more tabs to one of the edges that needs to be glued to another edge. In some implementations, one or more tabs may be added to both edges in a set of two edges that may need to be glued to each other.

In some implementations, tab placement may be refined to favor placing tabs consistently on one connected component of faces. Model construction module may use the connectivity information maintained between edges (as discussed above) during the initial cutting of a provided 3D mesh into a set of faces to determine which two faces may need to be glued to each other upon cutting. In some implementations, one or more tabs may be added to each edge of each face from the set of faces that is not connected to another edge.

Model construction module 210 is also configured to store information about the one or more planar mediums (e.g., one or more pages). Model constructions module 210 is also configured to provide the one or more planar mediums (e.g., from the stored set of planar mediums) containing the combined faces or original face (where it was large enough to take up one entire planar medium), including any added tabs, to the requesting user to construct the 3D model. One or more images may be generated from the set of planar mediums and the requesting user may then print the images of the set of planar mediums, cut, and glue together the images to construct a desired 3D model.

In various aspects, optimization module 220 is configured to provide two optimal faces to join to model construction module 210. Optimization module 220 may perform various calculations to determine which two faces are optimal for virtually gluing. For example, it may try all possible combinations of joining two faces, in a current set of faces, and provide the two faces that would yield the smallest perimeter (e.g., to reduce the total amount of cutting) to model construction module 210 for joining. A current set of faces may be those set of faces that still need to be processed, minus the faces that have already been processed. The current set of faces may include a face that has been joined previously with one or more other faces (as discussed above for model construction module 210). Optimization module 220 may take two faces having a longest common edge and provide those two faces for virtually gluing. Optimization module 220 may employ any other algorithm to decide which two faces should be combined and provide the two faces to model construction module 210 without deviating from the scope of this disclosure.

In some aspects, optimization module 220 is also configured to take into account constraints for joining two faces before providing them to model construction module 210 for digitally combining. One constraint may be to ensure that two pieces do not overlap before deciding on virtually gluing them. Overlapping faces may be determined by using existing software or solutions for intersection/overlapping tests. Optimization module 220 may also take into account any space requirements to add a possible tab to one or more edges of the faces, prior to providing two faces for virtual gluing. Another constraint that optimization module 220 may consider before providing two faces for virtual gluing may be to ensure that any needed tabs, in addition to the two faces, do not intersect and to ensure there is sufficient space on the planar medium to add the needed tabs. Upon determination of which two faces should be joined, optimization module 220 may be configured to provide the two selected faces to model construction module 210.

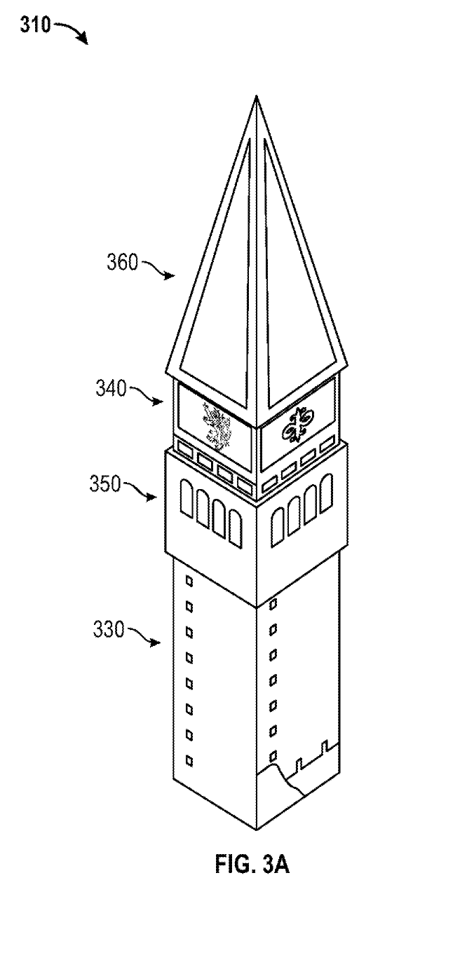

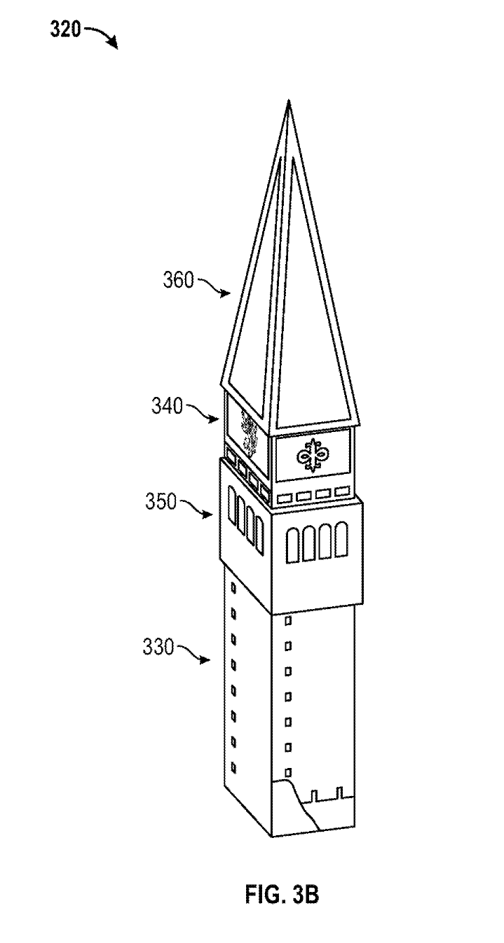

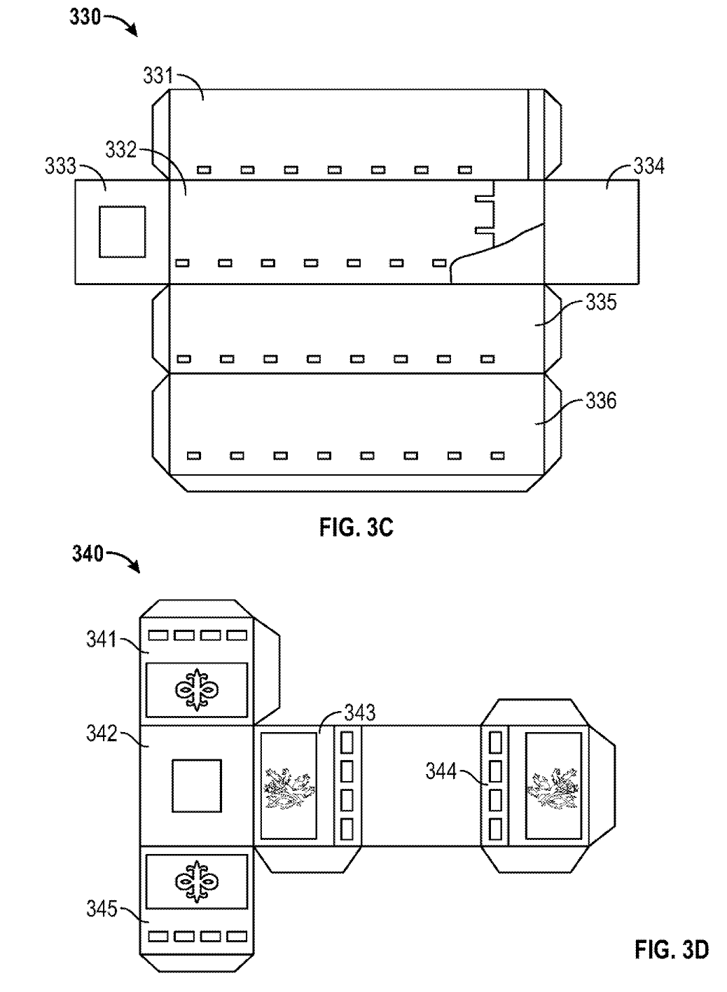

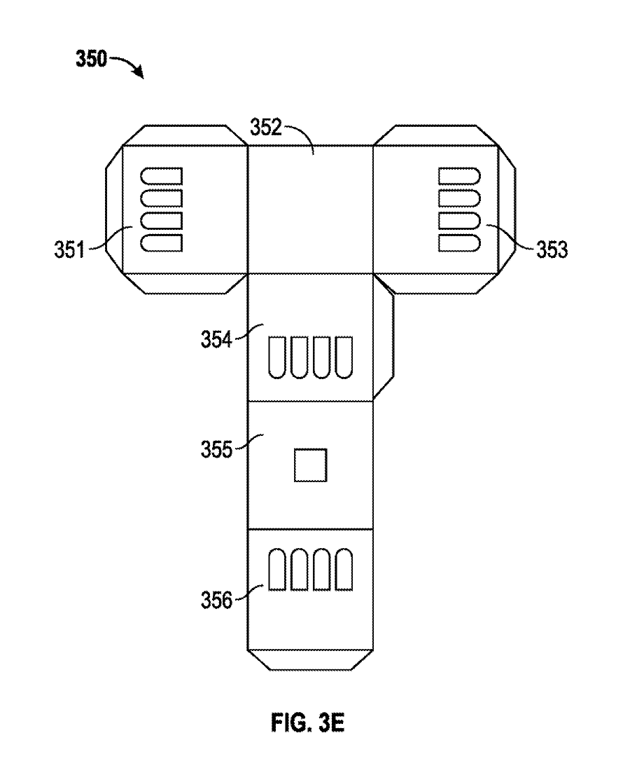

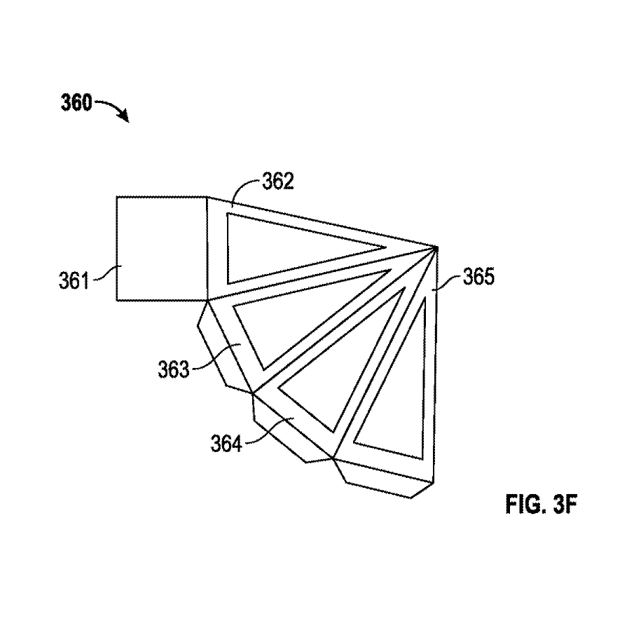

FIGS. 3A-3F illustrate an example of a 3D building and the pages resulting from applying a system 200 for model construction on the 3D building. FIGS. 3A and 3B show two views of a 3D building, views 310 and 320. The data for FIG. 3A or 3B may be provided as a 3D mesh to for example a system 200 for providing a 2D layout or set of pages for model construction.

FIGS. 3C and 3D illustrate one of the pages resulting from supplying a 3D mesh of building 310 for model construction to a system such as system 200. FIGS. 3C and 3D show two sets of faces that fit on one page of a set of pages resulting from applying a system 200. FIG. 3C illustrates a set of faces that make up a bottom section 330 of building 310. FIG. 3C shows, one result of applying a system 200, resulting in the set of faces 331, 332, 333, 334, 335, and 336, connected to one or more faces, providing a more optimized image for constructing section 330 of building 310. FIG. 3C illustrates that faces 331 and 335 have two tabs each, one on each end of the face that is not connected to any other face. Face 336 has 3 tabs, one on each side of the face that is not connected to any other face. Face 333 represents a face that may be glued to another similar face, to join section 330 with the adjacent section 350. Face 334 represents a bottom face of section 330 of building 310. Face 334 may rest on a surface where a constructed model may be placed.

FIG. 3D shows a section 340 of the building 310. Section 340 illustrates a set of faces that make up a middle section 340 of building 310. It shows, one result of applying a system 200, resulting in the set of faces 341, 342, 343, 344, and 345, connected to one or more faces to provide an optimized image for constructing section 340 of building 310. FIG. 3D illustrates face 341 having two tabs, face 343 and 345 having one tab, and face 344 having 3 tabs for later gluing to other edges. Both of the images for sections 330 and 340, containing digitally joined faces for the respective segment of the 3D building 310, are added to one page as the two sections could be accommodated on the available space for one page.

FIG. 3E shows a section 350 of the building 310 on a next page, as no more sections could be accommodated on the planar medium or page (e.g., referred to as a current page) containing sections 330 and 340. Section 350 illustrates a set of faces that make up a middle section 350 of building 310. It shows, one result of applying a system 200, resulting in the set of faces 351, 352, 353, 354, 355 and 356, connected to one or more faces to provide an optimized image for constructing section 350 of building 310. FIG. 3E illustrates face 354 and 356 having one tab each, and faces 351 and 353 having three tabs each.

FIG. 3F shows a section 360 of the building 310 on yet another page, as no more sections could be accommodated on the first two pages containing sections 330, 340 and 350. Section 360 illustrates a set of faces that make up a top section 360 of building 310. It shows, one result of applying a system 200, resulting in the set of faces 361, 362, 363, 364, and 365, connected to one or more faces to provide an optimized image for constructing section 360 of building 310. FIG. 3E illustrates faces 363, 364 and 365 having one tab each. Face 361 illustrates a face that may be connected or glued to an adjoining face of section 340.

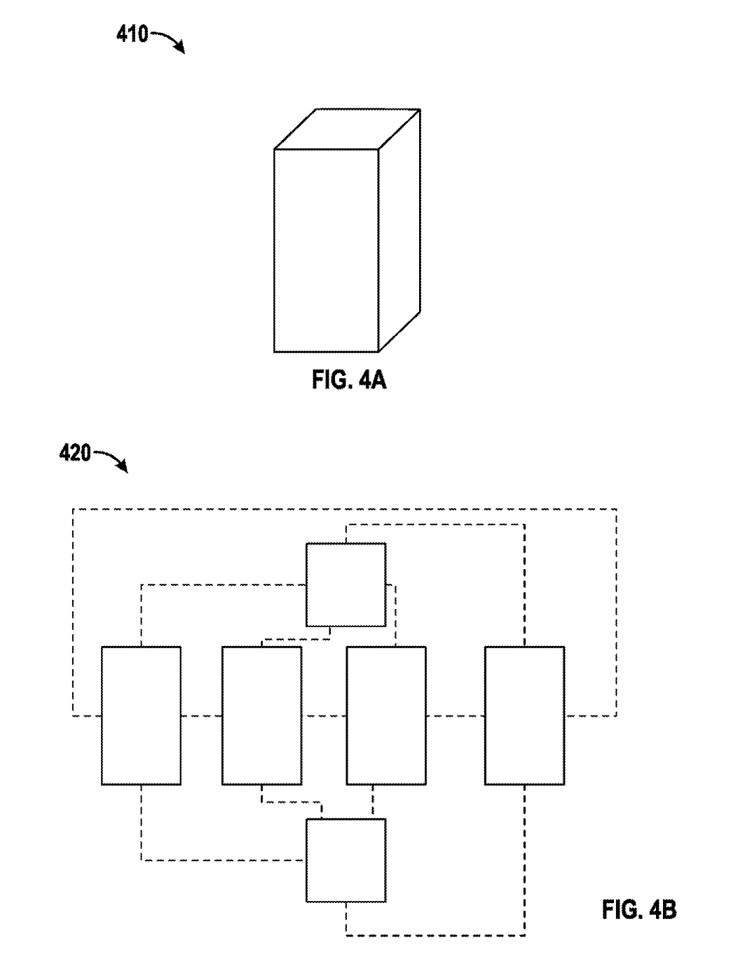

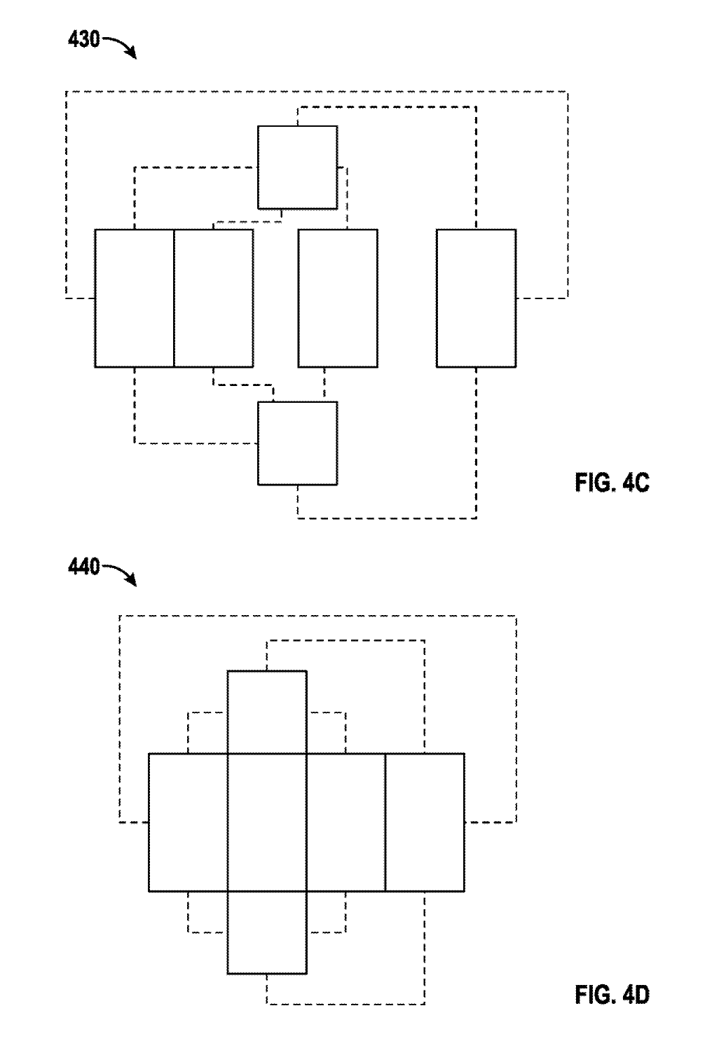

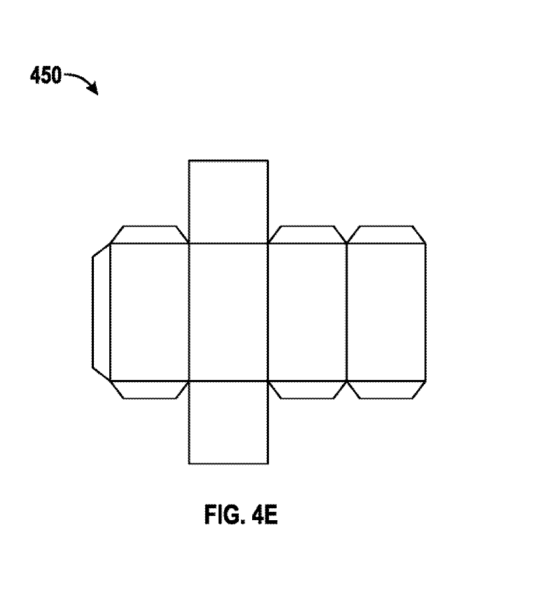

FIGS. 4A-4E illustrate an example of a 3D rectangular box and the pages resulting from applying a system 200 for model construction to the 3D rectangular box. FIG. 4A illustrates a rectangular box 410 for 3D modeling. The data for rectangular box 410 may be provided to a system 200 as a 3D mesh representation. FIG. 4B illustrates one set of faces that may result from taking an input 3D mesh, representing the 3D rectangular box of FIG. 4A, and creating (e.g., by digitally cutting or categorizing) a set of faces 420 that make up rectangular box 410. The set of faces 420 are shown to be connected by dotted lines, illustrating the connectivity information that may be maintained between edges and other edges as faces are being digitally cut from a provided 3D mesh.

FIG. 4C illustrates the selection of a first set of two faces from the set of faces 420 for combining, where the two faces have at least one edge in common, resulting in a set of faces 430. FIG. 4C shows the two left most faces are selected for joining along one edge. As the edge is joined, the dotted line, representing connectivity information, between the two selected faces is shown to be removed as that information may no longer be required for edges that have been virtually glued. FIG. 4C shows that state of the process where only one face has been connected to another face, resulting in requiring one less cut.

FIG. 4D illustrates the result of processing all faces in the set of faces 420, a set of connected faces 440. FIG. 4D illustrates all the faces of rectangular box 410 as connected to at least one other face. Additionally the dotted lines in the connected image 440 depicts the information that is maintained about what faces may need to be glued or joined to other faces for creating the 3D model of rectangular box 410. FIG. 4E illustrates the addition of tabs to the joined faces in FIG. 4D. As illustrated in the set of faces 450, multiple tabs have been inserted or added to three of the faces to accommodate gluing of those faces to other faces once drawing 450 is cut.

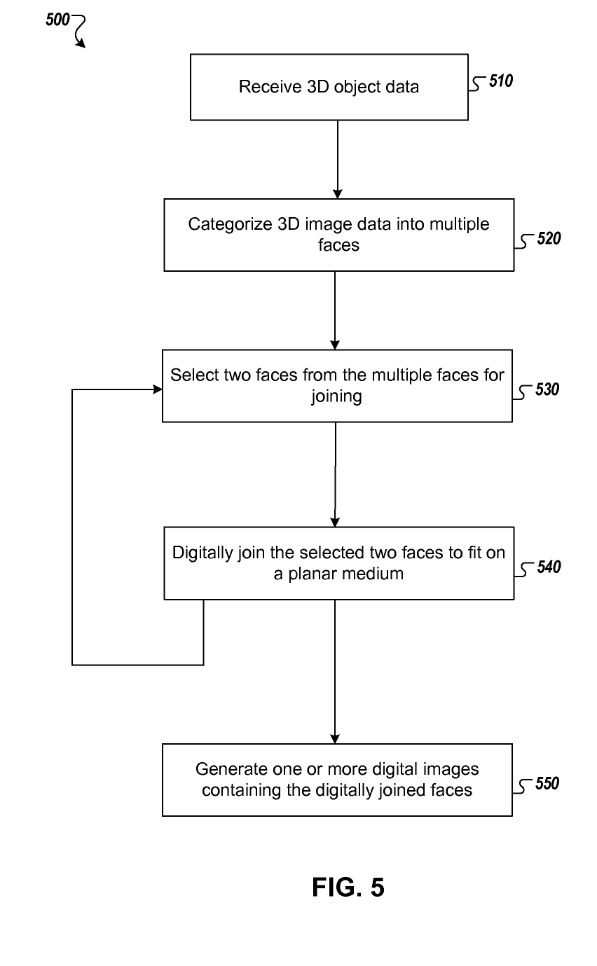

FIG. 5 illustrates a flow chart for an example process for model construction. Process 500 is an example process for the selective face aggregation technique (as discussed above) applied for 3D model construction. At step 510, 3D object data is received for model construction. The data may be received as 3D mesh data or any other suitable format that includes data for representing 3D surfaces.

At step 520, the received 3D mesh is categorized or digitally cut into multiple faces, e.g., a digital cut may be made for each face in the 3D mesh, resulting in a set of faces to select for digital joining. The digital cuts of faces may be constructed in such a way as to ensure that each face fits on one page. Step 520 may maintain connectivity information such as vertices and edges that join one face with another face.

At step 530 two faces are selected to virtually glue (e.g., to reduce the amount of cutting required). The two faces may be optimally selected, may be taking into account constraints, by optimization module 220 of system 200 as described above. Two faces selected at step 530 may be chosen as the optimal faces to combine based on various optimization algorithms. In some implementations, a greedy strategy is employed. At each step of attempted virtual gluing of two faces, with a common edge, a determination may be made about which two faces to virtually glue by calculating the total perimeter for all possible combinations, and selecting the combination that leads to the smallest perimeter for joining all the faces in the set of digital cuts. In some aspects, a greedy strategy results in the selection of combining two of the longest edges from a remaining set of digital cuts of faces to digitally join.

The selection of two faces to join at step 530 may take into account various constraints prior to determining which two faces should be virtually glued together. One constraint may be to ensure that two pieces do not overlap before deciding on virtually gluing them. Overlapping faces may be determined by using existing software or solutions for intersection/overlapping tests. Another constraint may be to ensure that there is enough space on a particular planar medium (e.g., a piece of paper on which the 2D image, combining two or more faces will be printed) before virtually gluing the selected faces at an edge. And yet another constraint may be to ensure that there is enough space on a current page to add any needed tabs and to ensure that the needed tabs, in addition to the two faces, do not intersect.

At step 540 the selected two faces are digitally joined on a planar medium, such as a current page being used for adding faces. Steps 530 and 540 may be repeated until all the faces in a set of faces created by step 520 have been processed (e.g., an attempt has been made to join each face with at least one other face in the set of faces created at step 520). At step 550, one or more digital images containing the digitally joined faces are generated. The one or more images may be generated from information stored about a set of planar mediums, containing one or more joined faces. The one or more images may be one image per page or planar medium, containing one or more digitally joined faces. Step 550 may insert or add one or more tabs to one or more edges (as discussed above) before or as part of generating the one or more digital images, prior to providing the pages to the requesting user or process.

One or more faces in the set of faces created by the categorizing or digital cutting in step 520 may not be joined with one or more other faces. For example, one or more faces may be so large as to require the space of a full page, thereby precluding the possibility of joining another face to it. Faces joined at step 540 may be used as a new face in the set of faces to which another face may be joined to. A second or next planar medium may be selected to join two selected faces when there is no more space on a (current) planar medium (e.g., between step 530 and 540). The next planar medium may then be used as the (current) planar medium to digitally join a set of selected two faces to. Steps 530 and 540 may be repeated, selecting a next page or planar medium where required, until all the faces in a set of faces created at step 520 have been processed.

The one or more planar mediums or pages, containing the one or more generated digital images at step 550, may be provided to a user or process that initiated step 510. For example, a browser or application that provided data that was received at step 510 may get the pages containing the optimized digital images constructed by a system 200 for model construction.

The described greedy strategy is one strategy for optimally selecting two faces for digitally joining. Other algorithms that may lead to a more global optimization may be employed instead, or supplemented with the greedy strategy. Such algorithms may include, but are not limited to, a breadth-first or depth-first search, recursively walking through all nodes/combinations, leading to a globally optimized solution for virtual gluing and edge selection.

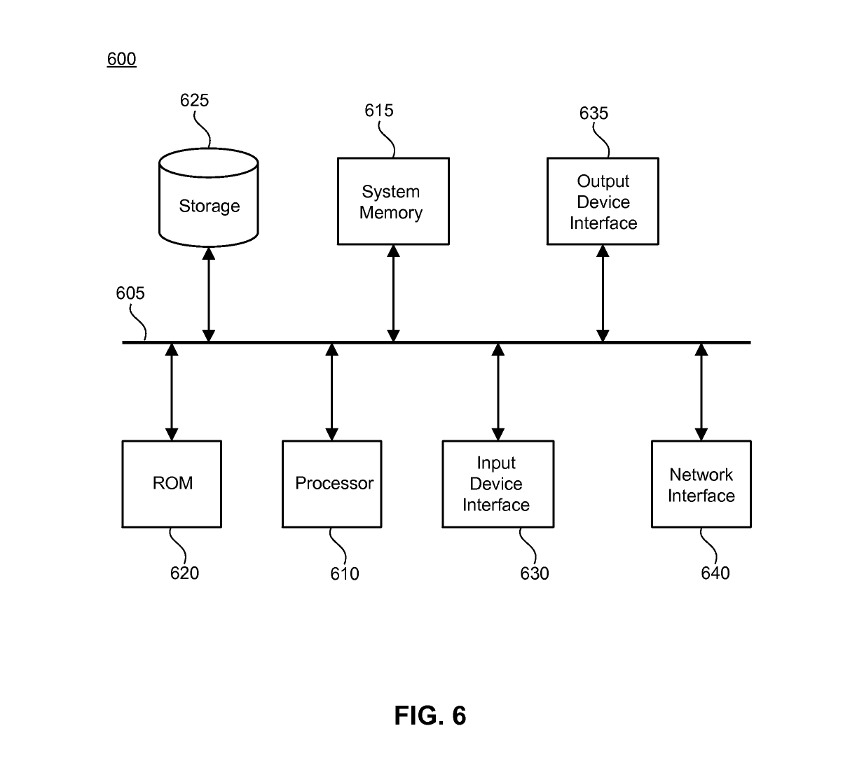

FIG. 6 conceptually illustrates an electronic system 600 with which some implementations of the subject technology are implemented. For example, one or more of the data repository 110, the server 120, mobile device 130 or the client computing device 140 of FIG. 1 may be implemented using the arrangement of the electronic system 600. The electronic system 600 can be a computer (e.g., a mobile phone, PDA), or any other sort of electronic device. Such an electronic system includes various types of computer readable media and interfaces for various other types of computer readable media. Electronic system 600 includes a bus 605, processing unit(s) 610, a system memory 615, a read-only memory 620, a permanent storage device 625, an input device interface 630, an output device interface 635, and a network interface 640.

The bus 605 collectively represents all system, peripheral, and chipset buses that communicatively connect the numerous internal devices of the electronic system 600. For instance, the bus 605 communicatively connects the processing unit(s) 610 with the read-only memory 620, the system memory 615, and the permanent storage device 625.

From these various memory units, the processing unit(s) 610 retrieves instructions to execute and data to process in order to execute the processes of the subject technology. The processing unit(s) can be a single processor or a multi-core processor in different implementations.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some implementations of the subject technology use a mass-storage device (for example a magnetic or optical disk and its corresponding disk drive) as the permanent storage device 625.

Other implementations use a removable storage device (for example a floppy disk, flash drive, and its corresponding disk drive) as the permanent storage device 625. Like the permanent storage device 625, the system memory 615 is a read-and-write memory device. However, unlike storage device 625, the system memory 615 is a volatile read-and-write memory, such a random access memory. The system memory 615 stores some of the instructions and data that the processor needs at runtime. In some implementations, the processes of the subject technology are stored in the system memory 615, the permanent storage device 625, or the read-only memory 620. For example, the various memory units include instructions for model construction in accordance with some implementations. From these various memory units, the processing unit(s) 610 retrieves instructions to execute and data to process in order to execute the processes of some implementations.

The bus 605 also connects to the input and output device interfaces 630 and 635. The input device interface 630 enables the user to communicate information and select commands to the electronic system. Input devices used with input device interface 630 include, for example, alphanumeric keyboards and pointing devices (also called “cursor control devices”). Output device interfaces 635 enables, for example, the display of images generated by the electronic system 600. Output devices used with output device interface 635 include, for example, printers and display devices, for example cathode ray tubes (CRT) or liquid crystal displays (LCD). Some implementations include devices for example a touchscreen that functions as both input and output devices.

Finally, as shown in FIG. 6, bus 605 also couples electronic system 600 to a network (not shown) through a network interface 640. In this manner, the electronic system 600 can be a part of a network of computers (for example a local area network (“LAN”), a wide area network (“WAN”), or an Intranet, or a network of networks, for example the Internet. Any or all components of electronic system 600 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

The detailed description set forth is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

It is understood that any specific order or hierarchy of steps in the processes disclosed is an illustration of example approaches. Based upon design preferences, it is understood that the specific order or hierarchy of steps in the processes may be rearranged, or that all illustrated steps may or may not be performed. Some of the steps may not be required and may not be executed. Some of the steps may be performed in an order different than illustrated. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

What is claimed is:

1. A computer-implemented method for generating a set of planar mediums for three dimensional model construction, the method comprising:
receiving three dimensional object data from a client computing device;
categorizing the three dimensional object data into a plurality of faces, wherein connectivity information for each face of the plurality of faces to other faces of the plurality of faces is maintained;
selecting two faces from the plurality of faces for digital joining;
digitally joining the selected two faces to fit on a planar medium; and
storing information about the planar medium containing the digitally joined faces.

2. The computer-implemented method of claim 1, wherein the selecting and digitally joining are repeated until no faces in the plurality of faces remain for selecting and digitally joining.

3. The computer-implemented method of claim 1, wherein the selecting and digitally joining are repeated until there is no more space on the planar medium to fit the selected two faces on the planar medium.

4. The computer-implemented method of claim 3, further comprising:
adding the current planar medium to a set of planar mediums; and
selecting a next planar medium to use as the planar medium for digitally joining the selected two faces when there is no more space left on the planar medium to fit the selected two faces.

5. The computer-implemented method of claim 4, wherein the selecting and digitally joining are repeated until an attempt has been made to join each face in the plurality of faces with at least one other face.

6. The computer-implemented method of claim 4, further comprising:
combining the generated one or more digital images from one or more planar mediums in the set of planar mediums where space permits the combining.

7. The computer-implemented method of claim 5, further comprising:
accessing the stored information about the planar mediums in the set of planar mediums;
generating one or more digital images based on the accessed stored information about the planar mediums in the set of planar mediums.

8. The computer-implemented method of claim 1, wherein the step for selecting the two faces from the plurality of faces for joining comprises selecting two faces that do no overlap each other.

9. The computer-implemented method of claim 1, wherein the step for selecting the two faces from the plurality of faces comprises ensuring that the two faces being selected for joining are the faces with a longest edge, wherein an edge represents a line connecting at least two faces.

10. The computer-implemented method of claim 1, wherein the selecting and digitally joining are repeated until each of the plurality of faces have been connected with at least one other face from the plurality of faces.

11. The computer-implemented method of claim 1, further comprising:
adding one or more tabs to one or more edges of one or more faces from the plurality of faces based on the maintained connectivity information for each face of the plurality of faces to other faces of the plurality of faces.

12. The computer-implemented method of claim 11, wherein the one or more tabs are represented by dotted lines.

13. The computer-implemented method of claim 11, wherein the one or more tabs are used after the generated one or more digital images are printed for model construction, to glue together one or more edges of the generated digital images.

14. A computer-readable medium storing instructions that when executed cause a computer to perform operations for generating a set of planar mediums for three dimensional model construction, the operations comprising:
receiving a 3D mesh from a client computing device, wherein a 3D mesh comprises of data representing a three dimensional surface;
categorizing the 3D mesh into a plurality of faces, wherein connectivity information for each face of the plurality of faces to other faces of the plurality of faces is maintained;
selecting two faces from the plurality of faces for digitally joining on a current planar medium;
selecting a next planar medium for digitally joining the selected two faces where no more space exists on the current planar medium for digitally joining the selected two faces;
adding the current planar medium to a set of planar mediums for model construction where a next planar medium has been selected;
setting the selected next planar medium as the current planar medium;
digitally joining the selected two faces to fit on the current planar medium;
repeating the steps for selecting two faces, selecting the next planar medium, and digitally joining the selected two faces until no faces remain in the plurality of faces for selecting and digitally joining; and
providing the set of planar mediums as output to the client computing device.

15. The computer-readable medium of claim 14, further comprising instructions that when executed cause a computer to perform operations comprising:
adding one or more tabs to one or more edges of the one or more digitally joined selected two faces.

16. The computer-readable medium of claim 15, wherein the added one or more tabs are represented as dotted lines.

17. A computer-implemented system for generating a set of planar mediums for three dimensional model construction, the system comprising:
one or more processors;
a memory comprising instructions which, when executed by the one or more processors, cause the one or more processors to:
receive data representing a three dimensional object from a client computing device;
categorize the data representing the three dimensional object into a plurality of faces, wherein each face represents a two dimensional polygon of a part of the three dimensional object, and wherein connectivity information for each face of the plurality of faces to other faces of the plurality of faces is maintained;
select two faces from the plurality of faces for digitally joining;
digitally join the selected two faces to fit on a planar medium; and
repeat the steps of selecting two faces and digitally joining the selected two faces until there is no more space on the planar medium for digitally joining the selected two faces.

18. The computer-implemented system of claim 17, further comprising instructions to:
select a next planar medium for digitally joining the selected two faces; and
digitally join the selected two faces to fit on the selected next planar medium.

19. The computer-implemented system of claim 18, further comprising instructions to:
repeat the steps to select, digitally join, and select a next planar medium until no faces remain in the plurality of faces for selecting and digitally joining.

20. The computer-implemented system of claim 19, further comprising instructions to:
add one or more tabs to one or more edges of the one or more digitally joined selected two faces.
